(19) United States
(12) Patent Application Publication
(10) Pub. No.: US 2008/0140526 A1
(43) Pub. Date: Jun. 12, 2008

(54) PUBLICATION DISTRIBUTION SYSTEM

(75) Inventors: Thomas A. Doran, St. Paul, MN (US); William Dornbach, Minnetonka, MN (US); Howard T. Quinlan, St. Paul, MN (US); John M. Ivancevich, Houston, TX (US); Margaret M. Morgan, St. Paul, MN (US); Edgar Laube, Madison, WI (US)

Correspondence Address: GRAY, PLANT, MOOTY, MOOTY & BENNETT, P.A., P.O. BOX 2906, MINNEAPOLIS, MN, 55402-0906, US

(73) Assignee: FREELOAD PRESS, INC., St. Paul, MN (US)

(21) Appl. No.: 11/758,951

(22) Filed: Jun. 6, 2007

Related U.S. Application Data
(60) Provisional application No. 60/812,449, filed on Jun. 12, 2006.

(51) Int. Cl. G06Q 90/00; B42D 15/00

(52) U.S. Cl. 705/14; 283/56

(57) ABSTRACT

A system of distributing publications including collecting information from a person, selecting a publication, customizing the publication through the addition of at least one advertisement and/or promotional material based upon the collected information, and distributing the publication to the person.

### REFERENCE TO RELATED APPLICATION

This patent application claims priority to U.S. Application No. 60/812,449, having a filing date of Jun. 12, 2006.

### FIELD OF THE INVENTION

The invention relates generally to publications. More particularly, the invention relates to a system of distributing publications having targeted advertisements placed therein.

### BACKGROUND OF THE INVENTION

There are various types of publications. There are two methods through which a significant portion of publications are distributed. The first method is a purchaser paid system where all of the costs associated with creating, reproducing and distributing the publication are borne solely by the purchaser. The second method involves placing advertisements in the publication to at least partially cover the costs of the publication.

Such a system works well for publications that are distributed in relatively high volumes. However, there are significant limitations associated with printing low volume books such as text books or books that are distributed over extended periods of time.

To enhance the efficiency of manufacturing books, the books are typically printed and bound in relatively large runs that are distributed over an extended period of time.

### SUMMARY OF THE INVENTION

The invention is directed to a publication distribution system. The system includes collecting information from a person, selecting a publication, customizing the publication through the addition of at least one advertisement and/or promotional material based upon the collected information, and distributing the publication to the person.

### DETAILED DESCRIPTION OF THE PREFERRED EMBODIMENTS

An embodiment of the invention is directed to a publication distribution system. The publication distribution system involves placement of advertisements and/or promotional messages in the publications that are targeted to a particular reader or group of readers.

Because the advertisements and/or promotional messages pay for a at least a portion of the costs associated with creating, reproducing and/or distributing the publications, the publication distribution system of this invention thereby reduces or eliminates the end user's expense of acquiring the publications.

In an embodiment of the publication distribution system, the publications are educational publications that are used in conjunction with classes, examples of which include text books, laboratory manuals, and study guides. In this embodiment, an instructor selects a particular educational publication that is to be used in conjunction with the class. As an alternative to purchasing a conventional pre-printed educational publication, the student may utilize the publication distribution system of this invention to obtain the educational publication.

The student may become aware of the availability of educational publications available using the publication distribution system using a variety of techniques such as the instructor including a link to the vendor's internet site in the course syllabus, a link to the vendor's internet site on the course web site, or an announcement in class with a link to the vendor's internet site. It is also possible for the student to obtain the link to the vendor's internet site from alternative mechanisms such as from peers, an internet search or partnership sites.

When the student visits the vendor's internet site, the student may use a variety of techniques to identify educational publications such as searching by subject, course number, instructor, title, author or ISBN. The desired educational publications are selected and added to the student's shopping cart. At the time the educational publications are being selected, the student may be given the option of selecting a variety of forms of the educational publications such as conventional pre-printed and electronic with advertisement or promotional messages.

Once the desired educational publications are selected and the student is ready to check out, the student may be requested to create an account that includes identifying information such as the student's name, address, login name, password, school name, course name/number, and instructor.

The publication distribution system may also include a survey that obtains additional information from the student. The surveys may ask the student questions that are intended to get a better understanding of factors that affect the student's buying decisions such as educational goals, clothing preferences, entertainment preferences, experiences with credit, and religion. The survey questions may be identified as being affiliated with particular entities, such as inquiring whether the student would like more information about particular vehicles or vacation destinations. Alternatively, the survey questions may address factors that are indicative of the student's likely desires for particular products and services.

The advertiser can pay a fee for a particular set of survey questions to be run for a selected number of students or for a selected length of time. Depending on the terms of the relationship between the vendor internet site, advertiser and student, the advertiser may receive summary reports relating to the survey results or the advertiser may receive data on the actual responses to the survey. The data may be distributed to the advertiser in a variety of mechanisms such as an internet site, an email or a printed document.

The surveys can also be used to enhance the ability to select advertisements and/or promotional messages for the student or group of students that will be using the educational publication. Through targeting the advertisements and/or promotional messages, the value of the advertisement and/or promotional message is increased.

Prior to being provided with access to the selected educational publication, the student may be requested to review and/or acknowledge the terms of an end-user license agreement that outlines the terms relating to the use of the educational publication, such as the ability of the student to use and make copies of the educational publication. The end-user license agreement may be prepared using input a variety of parties, such as the creator of the educational publication, the operator of the vendor's internet site and/or the advertiser.

While the advertisements and/or promotional messages are selected to minimize the potential that they would be offensive to the student or group of students using the educational publication, it is possible that certain individuals may find particular advertisement and/or promotional messages offensive. The end-user license agreement may include a hold harmless agreement that protects the parties who create, distribute and/or recommend the educational publication from liability relating to advertisements and/or promotional messages that are found to be offensive.

The student may then complete the check-out and be provided access to the educational publication. If the student selects a mode where advertisements and/or promotional messages are included in the educational publication, the educational publication may be obtained for no cost to the student. Alternatively, the educational publication may be provided to the student at a reduced cost compared to a conventional pre-printed version of the educational publication.

In one configuration, the student may be provided with a link to download the educational publication. Other potential mechanisms for distributing the educational publication to the student include attaching the educational publication to an email or sending the student an email with a link to download the educational publication. The educational publication may be downloaded either in its entirety or in portions thereof. Depending on the size of the publication, downloading the educational publication in its entirety may not be possible.

An advantage of downloading portions of the educational publication is that the time to download the educational publication is reduced so that the student can get what the student needs as the student needs it. Another advantage of downloading portions of the educational publication is that the student will need to visit the vendor's internet site on a periodic basis to thereby establish a stronger relationship between the student and the vendor such that the student will be more likely to utilize the vendor for additional products and services.

Still another advantage of downloading portions of the educational publication is that the vendor may require the student to complete additional surveys to evaluate the effectiveness of prior advertisements and/or promotional messages, as well as to assist in the placement of advertisements and/or promotional messages in the additional portions of the educational publication.

Through this process, the vendor must attempt to balance the number and length of surveys with time for the student to complete the surveys such that the advertiser receives a reasonable value for its expenses and the students also believe that the time to complete the surveys offsets the reduced cost to acquire the educational publication. In one configuration, the student may be limited to downloading five chapters before being requested to complete an additional survey.

The vendor would generate a version of the educational publication that includes advertisements and/or promotional messages that are selected based upon the student's account information, the student's responses to survey questions and the advertisers that are active at the time the educational publication is prepared. The advertisements and/or promotional messages are incorporated into the educational publication in a manner that balances the effectiveness of the advertisement with the ability of the educational publication to convey the educational material.

The advertisement and/or promotional messages may be reviewed prior to insertion into the educational publication to ensure that the advertisements and/or promotional messages comply with one or more of the following: federal laws, state laws, school regulations, and teacher requirements.

In one configuration, the advertisements and/or promotional messages may be placed at the beginning of the educational publication (front matter), at the end of the educational publication (back matter) and between chapters of the educational publication. It is also possible to incorporate advertisements and/or promotional messages in the textual portion of the educational publication. The advertisements and/or promotional messages may encompass an entire page or a portion of a page.

In one configuration where the advertisements and/or promotional messages are incorporated into the textual portion of the educational publication, they may be limited to no more than four advertisements and/or publications per chapter depending on the length of the chapter.

The educational publication may be distributed in a variety of forms. These forms may be device neutral and platform neutral such that accessing the educational publication does not depend on having particular hardware or a particular operating system. The forms may place restrictions on the ability of the student to do various tasks with the educational publication such as modifying, printing, and copying the educational publication. One format for distributing the educational publication is PDF.

It is also possible to provide access to the educational publication through an internet-based viewer. While limiting access to the educational publication through an internet-based viewer provides the vendor with the ability to change advertisements and/or promotional messages each time the student views the educational publication, the student's ability to use the educational publication is limited to areas where the student has internet access.

When the educational publication is downloaded, it is possible to include an expiration date that limits the length of time in which the educational publication may be accessed. If the student desires to access the educational publication beyond the expiration date, the student may visit the vendor's internet site to either download another copy of the educational publication or to obtain a code to extend the expiration date of the previously downloaded educational publication.

To enhance the ability of the student to access the product or service included in the advertisements and/or promotional messages, each advertisement and/or promotional message may include a link to obtain more information about the product or service. The link may directly connect to the internet site where the additional information is provided. Alternatively, the link may route through the vendor's internet site to assist the vendor in tracking the responses to particular advertisements by particular students.

During the checkout process, the student may also be provided with access to special promotions based upon a variety of factors such as the educational publication selected, student's demographic information, school, and survey responses. The special promotions may include a variety of products and/or services such as other educational publications, educational services, and discounts on other products and services like clothing and restaurants.

Another potential value of the publication distribution system is the ability to track the preferences of students as they grow. For example, it is possible to track how the students respond to survey questions over successive years to get a better understanding of the students' buying preferences.

The preceding concepts are described with respect to students in traditional educational systems such as college, high school and grade school. The concepts are also adaptable to other educational applications such as life-long learners and community education. In these applications, the advertisement and/or promotional messages may be used to provide the students with information about other programs or classes that are available.

While the concepts of the publication distribution system are described above with respect to educational applications, it is possible to use the concepts of the present invention in other types of publications, examples of which include fiction, non-fiction, cooking, travel and reference, and certification training. It is also possible to utilize the concepts of the invention in conjunction with other types of products, examples of which include audio and video.

While the concepts of publication distribution system are described above with respect to utilizing the internet, it is also possible to utilize the concepts of this invention through alternative mechanisms such as a telephone network or through in-person interviews.

It is contemplated that features disclosed in this application, as well as those described in the above applications incorporated by reference, can be mixed and matched to suit particular circumstances. Various other modifications and changes will be apparent to those of ordinary skill.

1. A system of distributing publications comprising:
collecting information from a person;
selecting a publication;
customizing the publication through the addition of at least one advertisement and/or promotional material based upon the collected information; and
distributing the publication to the person.

2. The system of claim 1, wherein collecting information from the person comprises the person's name, address, login name, password, school name, course name, course number, instructor or combination thereof.

3. The system of claim 1, wherein collecting information from the person comprises having the person complete a survey.

4. The system of claim 3, wherein the survey comprises questions that are intended to get a better understanding of factors that affect the person's buying decisions.

5. The system of claim 1, wherein selecting the publication comprises searching for the publication by subject, course number, instructor, title, author, ISBN or combination thereof.

6. The system of claim 1, wherein customizing the publication comprises placing the at least one advertisement at a beginning of the publication, at an end of the publication, between sections of the publication, at an intermediate location in the publication or combinations thereof.

7. The system of claim 1, wherein the at least one advertisement and/or promotional message includes a link or other contact information to obtain more details about the advertisement and/or promotional message.

8. The system of claim 1, wherein distributing the publication comprises downloading the publication in electronic form, accessing via a browser or combinations thereof.

9. The system of claim 1, wherein the publication is distributed in a format that is device neutral, platform neutral or combination thereof.

10. The system of claim 1, and further comprising adding restrictions to the publication selected from the group consisting of viewing, modifying, printing, copying or combinations thereof.

11. The system of claim 1, and further comprising limiting a duration over which the publication may be accessed.

12. The system of claim 11, and further comprising having the person complete a survey to extend the duration over which the publication may be accessed by completing a survey.

13. The system of claim 1, and further comprising periodically changing the at least one advertisement and/or promotional message.

14. The system of claim 1, wherein distributing the publication comprises downloading a first portion of the publication.

15. The system of claim 14, and further comprising having the person complete a first survey before downloading the first portion of the publication.

16. The system of claim 15, and further comprising having the person complete a second survey before downloading a second portion of the publication.

17. The system of claim 1, wherein distributing the publication comprises printing the publication on a media.

18. The system of claim 1, and further comprising having the person acknowledge the terms of a license agreement prior to the distributing the publication, wherein the license agreement provides terms under which the publication is being distributed.

19. The system of claim 18, wherein the license agreement limits the ability of the person to object to advertisements and/or promotional messages that the person finds offensive.

20. The system of claim 1, wherein the publication is in the field of education, fiction, non-fiction, cooking, traveling, reference, certification training or combination thereof.
